(19) United States
(12) Patent Application Publication
(10) Pub. No.: US 2010/0186610 A1
(43) Pub. Date: Jul. 29, 2010

(54) METHOD AND APPARATUS FOR PRINTING IMAGES

(75) Inventors: Michael Lane Polk, Mint Hill, NC (US); Gregory L. Franklin, Indian Trail, NC (US)

Correspondence Address: OLIVE LAW GROUP, PLLC, 130 EDINBURGH SOUTH DRIVE, SUITE 107, CARY, NC, 27511, US

(73) Assignee: INNOVATIVE PRINTER TECHNOLOGIES, LLC, Dallas, NC (US)

(21) Appl. No.: 12/361,584

(22) Filed: Jan. 29, 2009

(51) Int. Cl. B41J 17/00

(52) U.S. Cl. 101/35

(57) ABSTRACT

A tray for holding at least one object while an image is printed on a predetermined exposed portion of the object, including at least one object retainer carried by the tray and for positioning the object in a stationary condition in relation to the tray during printing, a panel carried by the tray and having at least one opening positioned in relation to the object retainer such that the exposed portion of the object is exposed to ink projected onto the object from an ink-projecting apparatus positioned in spaced-apart relation to the object, and an indexer carried by the tray for permitting relative movement between the tray and the ink-projecting apparatus as the image is printed on the exposed portion of the object.

### TECHNICAL FIELD AND BACKGROUND OF THE INVENTION

The present invention relates to the field of image printing systems. In particular, the invention relates to an image printing apparatus and method capable of printing images on curved and spherical substrates.

Currently, there are several methods being used to print images on the surfaces of objects. Typically, these methods incorporate a printer spaced apart from a tray holding of plurality of objects. However, these methods do not address the issue of varying distances between the surfaces to be printed and the print head; rather, they attempt to maintain a constant distance by curving the travel of the print head relative to the curvature of the substrate, or by moving the substrate during ink projection to maintain this distance. Additionally, these methods do not compensate for droplet loss due to droplets that are directed away from the substrate, causing density loss and an image that is out-of-focus or slightly fuzzy. Furthermore, overspray from an ink print head may cause a less than desirable image print.

Thus, it is desirable to provide an image printing system and method to improve the image clarity and color when printing on curved and spherical surfaces by maintaining a constant object distance from the print head and providing a shield to prevent overspray from reaching the object.

### SUMMARY OF THE INVENTION

Therefore it is an object of the invention to provide an image printing system that maintains a constant distance between a print head and the object to be printed upon.

It is another object of the invention to provide a tray designed to hold a plurality of objects in the same respective position relative to an external location.

It is another object of the invention to provide an image printing system that permits accurate, clear application of images on flat, curved, spherical, regular and irregular substrates.

It is another object of the invention to provide an image printing system that controls droplet rebound during image creation.

These and other objects of the present invention are achieved in the preferred embodiments disclosed below by providing a tray for holding at least one object while an image is printed on a predetermined exposed portion of the object. The tray includes at least one object retainer carried by the tray and for positioning the object in a stationary condition in relation to the tray during printing. A panel is carried by the tray and has at least one opening positioned in relation to the object retainer such that the exposed portion of the object is exposed to ink projected onto the object from an ink-projecting apparatus positioned in spaced-apart relation to the object. An indexer is carried by the tray for permitting relative movement between the tray and the ink-projecting apparatus as the image is printed on the exposed portion of the object.

According to another embodiment of the invention, each object retainer comprises a longitudinally extending member having a biasing element attached thereto and extending in a generally horizontal plane beneath the object for biasing the object against the panel.

According to another embodiment of the invention, each opening is sized for receiving the object and for defining a print area of the object.

According to another embodiment of the invention, each opening is generally circular and is sized for receiving a generally convex object.

According to another embodiment of the invention, the tray further includes a recess defining an area of reduced thickness extending from each opening to a bottom side of the panel for receiving the object.

According to another embodiment of the invention, the tray further includes a recess defining an area of reduced thickness extending from each opening to a top side of the panel for reducing print ink deflection at each respective opening.

According to another embodiment of the invention, the tray further includes a plurality of spaced apart openings arranged in a series of successive rows such that the exposed portion of a plurality of objects positioned within the plurality of openings is exposed to ink projected onto the plurality of objects from the ink-projecting apparatus.

According to another embodiment of the invention, the indexer comprises a conveyor for conveying the tray under the print head in coordination with printing of the image on successive rows of objects.

According to another preferred embodiment of the invention, a printing system for printing an image on a predetermined exposed portion of a plurality of objects is provided. The system includes a print tray for holding the plurality of objects while the image is printed on the object, a plurality of object retainers for positioning the plurality of objects in a stationary condition in relation to the print tray during printing, a printer having a print head spaced apart from the tray, a panel carried by the tray and having a plurality of openings positioned in relation to each respective object retainer such that the exposed portion of each object is exposed to ink projected onto the object from the print head, and an indexer carried by the tray for permitting relative movement between the tray and the printer as the image is printed on the exposed portion of each successive object.

According to another embodiment of the invention, the printer further includes digital storage means for storing the image to be printed on an image surface of the object.

According to another embodiment of the invention, the indexer comprises a conveyor for conveying the tray under the print head in coordination with printing of the image on the object for printing on successive objects as the objects pass under the print head.

According to another embodiment of the invention, the indexer comprises a conveyor for conveying the print head above the tray in coordination with printing of the image on the object for printing a successive row of objects.

According to another preferred embodiment of the invention, a print tray for covering predetermined unexposed portions of at least one object to be printed on is provided. The tray comprises a substantially flat panel defining at least one opening for exposing predetermined exposed portions of the at least one object, such that the exposed portion of the at least one object is exposed to ink projected from an ink-projecting apparatus positioned in spaced-apart relation to the print tray.

According to another preferred embodiment of the invention, a method for printing an image on an exposed portion of an object is provided, including providing a tray having an opening on an upper panel for receiving an object thereunder onto which printing is to be applied, providing a printer having a print head positioned in spaced-apart ink-applying relation to the tray, placing the object in the tray with a portion exposed in the opening, and applying the image to the exposed portion of the object as the print head and the tray are moved relative to one another.

According to another embodiment of the invention, the method further includes the step of storing the image to be printed on the image surface of the object in an electronic data store and the printer receiving electronic data representing the image to be printed.

### BRIEF DESCRIPTION OF THE DRAWINGS

The invention may be best understood by reference to the following description in conjunction with the accompanying drawing figures in which:

FIG. 1 is a perspective view of an image printing system according to an embodiment of the invention;

FIG. 2 is a perspective view of an image printing system of FIG. 1 printing on a spherical object;

FIG. 3 is a partial top view of a printing tray according to an embodiment of the invention;

FIG. 4 is a partial bottom view of a print tray according to an embodiment of the invention;

FIG. 5 is a bottom view of a print tray according to an embodiment of the invention;

FIG. 6 is a side view of a print tray according to an alternate embodiment of the invention;

FIG. 7 is a bottom view of a print tray according to an alternate embodiment of the invention; and

FIG. 8 is a partial bottom view of a print tray according to an alternate embodiment of the invention.

### DESCRIPTION OF THE PREFERRED EMBODIMENT AND BEST MODE

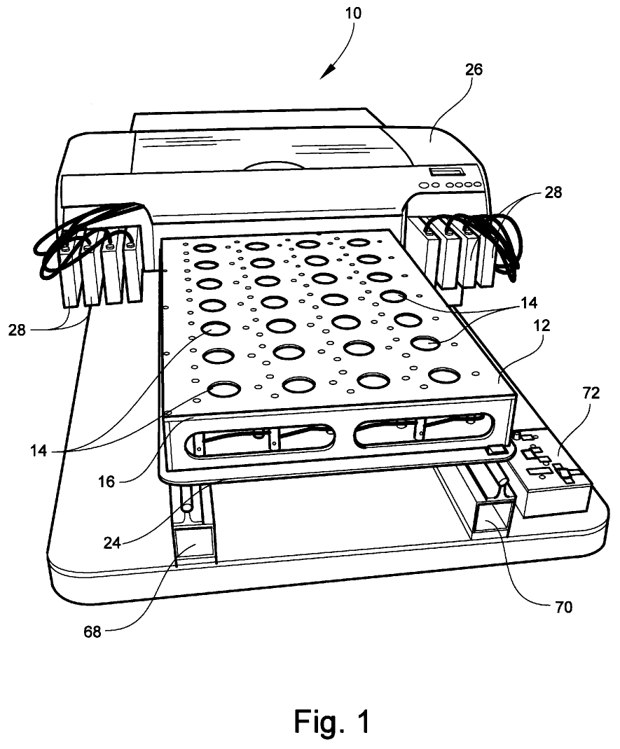

Referring now specifically to the drawings, an image printing system according to an embodiment of the invention is illustrated in FIG. 1 and shown generally at reference numeral 10. The printing system 10 includes a printer 26 and ink supply 28. The ink supply 28 includes different colors of ink and is suitable for an operator's desired use. A tray 12 is provided and configured to slide underneath the printer 26 by a conveyor system 67 formed by a pair of spaced apart and generally parallel rails 68 and 70 mounted on a platen support 66. The rails 68, 70 are designed such that the tray 12 is able to slide underneath the printer 26 in response to a mechanical input designed to impart linear movement to the tray 12. Any means that will impart movement to the tray 12 may be used. Examples include a linear actuator, conveyor track, and/or automated robotic system designed to slide the tray 12. A controller system 72 is suitably attached to control the electrical components of the system. In alternate embodiments, tray 12 may be used alone and employ any suitable retaining means to hold the objects to be printed upon.

The tray 12 has an upper panel 16 and a lower panel 24 and is generally constructed in a rectangular shape. In some instances, the upper panel 16 and the lower panel 24 are removably attached to the tray 12. The tray 12 includes a plurality of openings 14 that are shaped to receive a round, generally spherical, oval, or convex shape. In appropriate instances, the tray openings 14 may be designed to fit other geometric shapes.

The printer 26 is a flatbed printer and includes the platen support 66 on which a housing 62 is also mounted. The pair of parallel, spaced-part carriage support rails 68, 70 are mounted on the platen support 66 perpendicular to the side-to-side motion of the print head 27. The tray 12 is mounted on the carriage support rails 68,70 and is controlled in the manner described above whereby objects carried on the tray 12 are precisely positioned in relation to the print head 27 to receive ink in a pattern controlled by the controller system 72 and associated software. The tray 12 shown is exemplary of any suitable tray as would be designed and sized to accept particular objects to be printed.

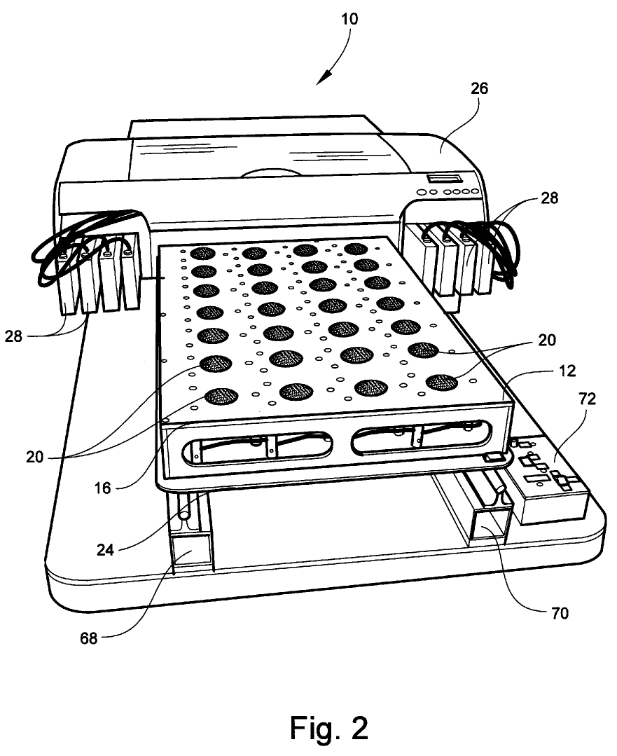

Referring now to FIG. 2, a specific example is shown where the printing system 10 is printing an image on an object 20, in this case a golf ball. The object 20 is positioned within the tray 12 by inserting the object 20 into the tray 12 so that only the desired printable portion of the object 20 is left exposed through the opening 14. Ink is thus applied onto the targeted print area, with the surrounding parts of the tray 12 acting as a spray shield to prevent ink application to the remainder of the object 20.

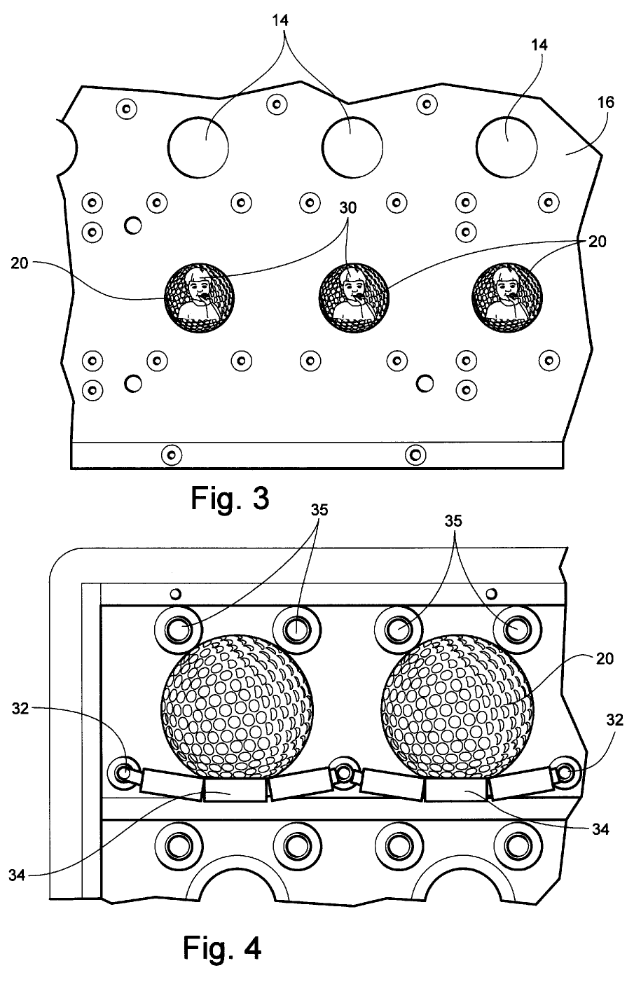

As shown in FIGS. 3-5, the tray 12 includes objects 20 placed in the openings 14. FIG. 3 is a view of the upper surface of the top panel 16 of the tray 12 and FIG. 4 is a view of the lower surface of the top panel 16 of the tray 12. As shown in FIG. 3, only the exposed portion of the object 20 has the image 30 printed thereon. As shown in FIG. 4, a plurality of positioning posts 32 and 35 extend outwardly from the bottom side of the top panel 16 of the tray. In the embodiment shown in FIG. 4, a deflectable biasing member 34 in the form of a spring or elastic band inside a plurality of short tube sections extends between the pair of positioning posts 32 and works to maintain the exposed portion of the object 20 in a fixed position relative to the opening 14. Together, the posts 32 and 35 function with the biasing member 34 to position and maintain the object 20 in the correct stationary position. In this manner, the exposed portion of the object 20 maintains the same distance from the print head 27.

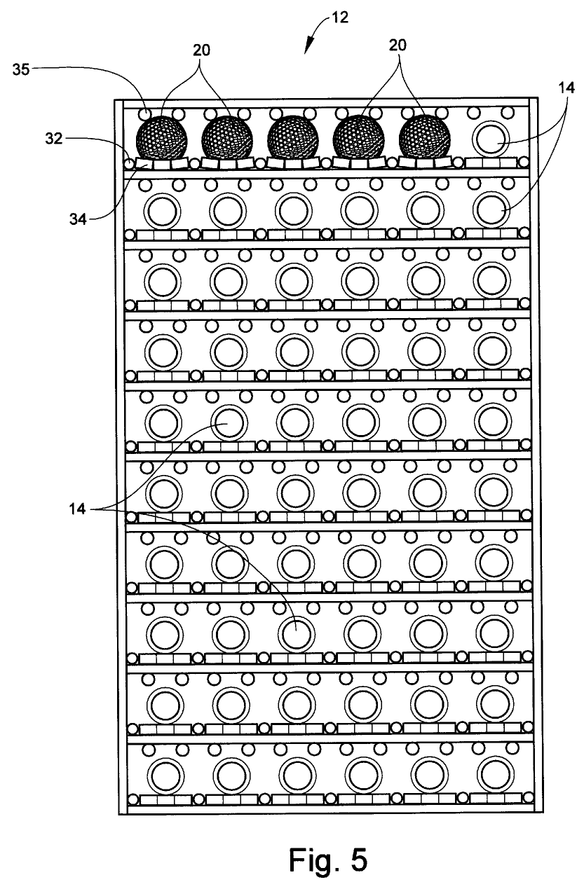

As shown in FIG. 5, the tray 12 includes a plurality of spaced apart openings 14 that are positioned in any suitable manner, and in this case, spaced in a series of rows designed such that the printer 26 is able to print successive rows of objects 20, such as golf balls. An annular recess 37 around each opening 14 is provided and designed so as to allow a curved or generally spherical object such as a golf ball to mount flush against the top panel 16 of the tray 12. Any shaped recess that will maintain the object 20 flush against the panel 16 of the tray 12 may be used.

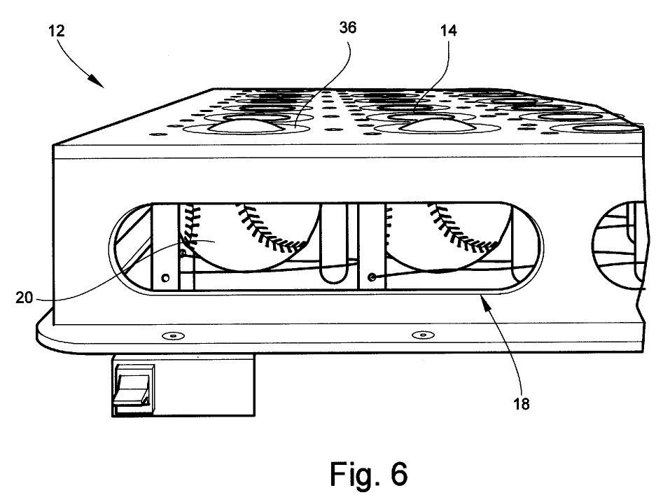

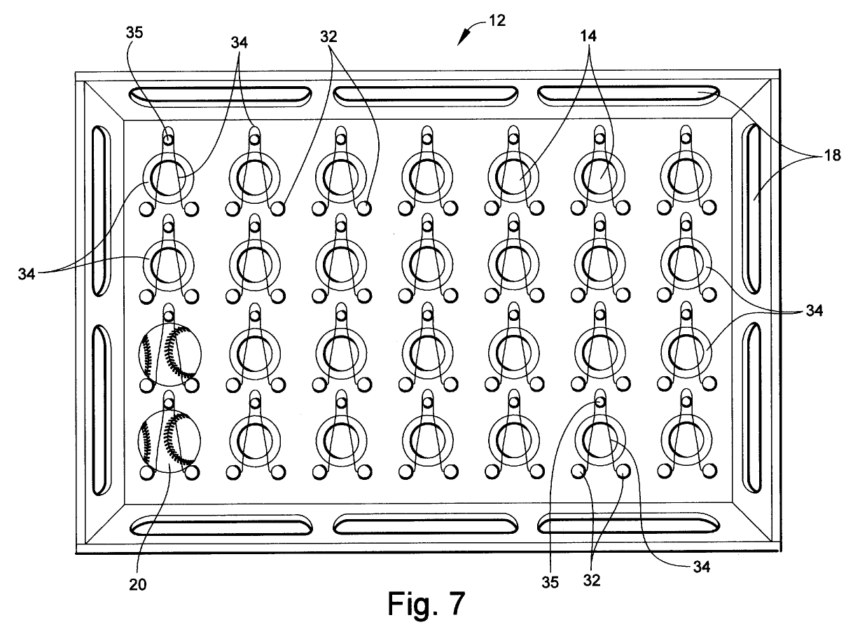

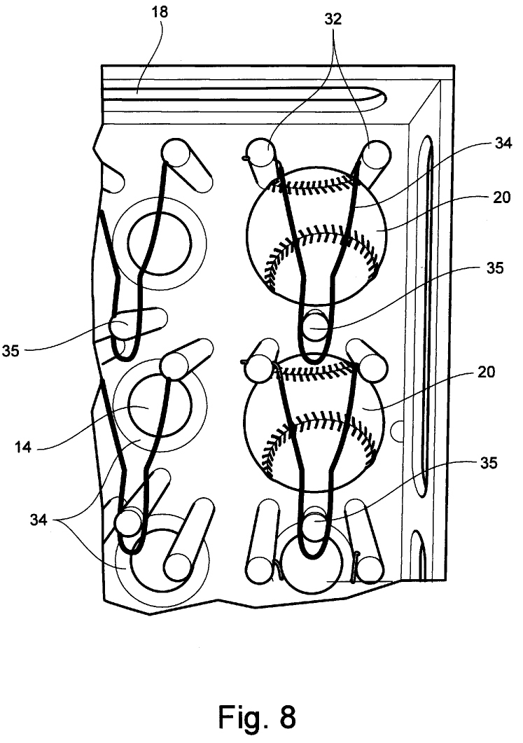

As shown in FIGS. 6-8, an alternate embodiment according to the present invention is represented by a tray 112. The tray 112 is used to print images on an object 120, in this case a baseball. The tray 112 includes many of the features shown in the previous drawings. The object 120 is positioned within the tray 112 by inserting the object 120 into the tray 112 so that only the desired printable portion of the object 120 is left exposed through an opening 114. Ink is thus applied onto the targeted print area, with the surrounding parts of the tray 112 acting as a spray shield to prevent ink application to the remainder of the object 120. Openings 118 are formed within the tray 112, providing handles for the tray 112, and reducing the weight of the tray 112. These openings 118 permit both a relatively thick, rigid, vibration-resistant structure while reducing weight and material cost. An annular recess 136 is provided on the upper surface of the top panel 116 of the tray 112, and an annular recess 137 is provided on the lower surface of the top panel 116 of the tray 112. The recess 136 reduces the thickness of the tray 112 around the object 120 and presents a smaller area that may deflect ink spray onto the object 120. The recess 137 is designed to allow a curved or generally spherical object to mount flush against the top panel 116 of the tray. While recesses 136, 137 are shown in the Figures as bevels, in appropriate circumstances, any suitable recess of reduced thickness extending from each opening 114 to one side of the panel 116 may be utilized.

In the embodiment shown in FIGS. 6-8, posts 132 are spaced apart and surround the perimeter of the object 120 such that the object 120 is held in the desired, fixed position. A post 135 is provided and configured to receive a “U” spring clip 134 that extends from the posts 132 and releasably latches over the post 135. Together, the posts 132, 135 and the post 134 hold the object 120 according to the embodiment shown in FIGS. 6-8. In this embodiment, the clip 134 is configured to deform about a point on the post 135 such that, as the clip 134 is in an open position rotated away from the object 120, the object 120 can be inserted into the opening 114. The clip 134 is then rotated into and latched over the post 135.

The printer 26 may have image storing capabilities provided from a computer. The computer renders a desired digital image to the required size and color, or accesses digital images previously rendered, before transferring the image by means of control software that interfaces with the ink jet print head 27. For illustrative purposes only, in the embodiment shown in FIG. 1, the printer 26 is a 1440 dpi printer and the print head 27 is vertically adjusted in increments of 0.025 inches.

The printer 10 further includes digital storage means for storing the image to be printed on an image surface of the object. Such digital storage means include computer access to a hard drive, random access memory, magnetic disk, floppy disk, CD-ROM, Ultra Density Optical disk and related storage, holographic, phase change, direct or indirect-attached network storage, NAND storage including a flash drive, and technological derivations thereof both present and in the future.

From the starting position shown in FIG. 1, the tray 12 is driven into the printer 26 under the control of the controller system 72, as the print head 27 is moved back-and-forth, ejecting a precisely-controlled spray of ink towards the surface of the objects 20. The objects 20 are printed on their top, curved surface as shown, or in alternate embodiments, on a flat, angled, or other suitable surface. Tray 112 is operable with the printer 26 in the same manner as tray 12.

For illustrative purposes only, in the embodiment shown in FIG. 5, tray 12 includes six vertically positioned rows and ten horizontally positioned intersecting rows and is therefore capable of holding 60 objects. The opening 14 has a 0.85″ diameter creating an image surface diameter of approximately 0.80″. In the embodiment shown in FIG. 6, tray 112 includes four horizontally positioned rows and seven vertically positioned intersecting rows and is therefore capable of holding 28 objects. The opening 114 has a 1.50″ diameter creating an image surface diameter of approximately 1.45″. Each opening 14 and 140 is sized such and cooperated with each respective recess, 36, 36, 136, and 137 to create the largest possible printable image area.

The apparatus and method as described above may be applied in several ways. For example, in some embodiments it may be preferable to apply a pre-coat adhesive to the object 20 for better surface adhesion.

The above example is merely illustrative, and other substrates may be printed as described above, as well as flat substrates such as glass, tile or ceramic ornaments. Specific objects which can be printed as described above include round, spherical or curved objects such as sporting balls including but not limited to baseballs, golf balls, footballs, basketballs, softballs or soccer balls, paper, Mylar, cardboard, overlays, stickers and the like, or rigid substrates such as glass, tile, ceramics, wood, plastic, hardboard, and the like, as well as textile materials such as fabrics used in t-shirts and other clothing, hats, footwear, or other apparel.

An image printing apparatus and method is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

We claim:

1. A tray for holding at least one object while an image is printed on a predetermined exposed portion of the object, comprising:
(a) at least one object retainer carried by the tray and for positioning the object in a stationary condition in relation to the tray during printing;
(b) a panel carried by the tray and having at least one opening positioned in relation to the object retainer such that the exposed portion of the object is exposed to ink projected onto the object from an ink-projecting apparatus positioned in spaced-apart relation to the object; and
(c) an indexer carried by the tray for permitting relative movement between the tray and the ink-projecting apparatus as the image is printed on the exposed portion of the object.

2. The apparatus according to claim 1, wherein each object retainer comprises a longitudinally extending member having a biasing element attached thereto and extending in a generally horizontal plane beneath the object for biasing the object against the panel.

3. The apparatus according to claim 1, wherein each opening is sized for receiving the object and for defining a print area of the object.

4. The apparatus according to claim 1, wherein each opening is generally circular and is sized for receiving a generally convex object.

5. The apparatus according to claim 1, further including a recess defining an area of reduced thickness extending from each opening to a bottom side of the panel for receiving the object.

6. The apparatus according to claim 1, further including a recess defining an area of reduced thickness extending from each opening to a top side of the panel for reducing print ink deflection at each respective opening.

7. The apparatus according to claim 1, further including a plurality of spaced apart openings arranged in a series of successive rows such that the exposed portion of a plurality of objects positioned within the plurality of openings is exposed to ink projected onto the plurality of objects from the ink-projecting apparatus.

8. The apparatus according to claim 1, wherein the indexer comprises a conveyor for conveying the tray under the print head in coordination with printing of the image on successive rows of objects.

9. A printing system for printing an image on a predetermined exposed portion of a plurality of objects, comprising:
(a) a print tray for holding the plurality of objects while the image is printed on the object;
(b) a plurality of object retainers for positioning the plurality of objects in a stationary condition in relation to the print tray during printing;
(c) a printer having a print head spaced apart from the tray for printing the image on the exposed portion of each object;
(d) a panel carried by the tray and having a plurality of openings positioned in relation to each respective object retainer such that the exposed portion of each object is exposed to ink projected onto the object from the print head; and
(e) an indexer carried by the tray for permitting relative movement between the tray and the printer as the image is printed on the exposed portion of each successive object.

10. The apparatus according to claim 9, wherein the printer further includes digital storage means for storing the image to be printed on an image surface of the object.

11. The apparatus according to claim 9, wherein each object holder comprises a longitudinally extending member having a biasing element attached thereto and extending in a generally horizontal plane beneath each object for biasing each object towards a respective opening of the at least one opening.

12. The apparatus according to claim 9, wherein each opening is sized for receiving each object and for defining a print area of the object.

13. The apparatus according to claim 9, wherein each opening is generally circular and is sized for receiving an object having a convex printable surface.

14. The apparatus according to claim 9, wherein the tray includes a recess defining an area of reduced thickness surrounding the opening for reducing an amount of ink deflected from the frame onto the object being printed.

15. The apparatus according to claim 9, wherein the opening is circular and the object retainers are adapted for receiving and holding spherical objects to be printed.

16. The apparatus according to claim 9, wherein the indexer comprises a conveyor for conveying the tray under the print head in coordination with printing of the image on the object for printing on successive objects as the objects pass under the print head.

17. The apparatus according to claim 9, wherein the indexer comprises a conveyor for conveying the print head above the tray in coordination with printing of the image on the object for printing a successive row of objects.

18. A print tray for covering predetermined unexposed portions of at least one object to be printed on, comprising a substantially flat panel defining at least one opening for exposing predetermined exposed portions of the at least one object, such that the exposed portion of the at least one object is exposed to ink projected from an ink-projecting apparatus positioned in spaced-apart relation to the print tray.

19. The print tray according to claim 18, wherein each opening of the at least one opening is sized for receiving each object of the at least one object and for defining a print area of the object.

20. The print tray according to claim 18, wherein each opening of the at least one opening is generally circular and is sized for receiving a generally convex object.

21. The print tray according to claim 18, further including a recess defining an area of reduced thickness extending from each opening of the at least one opening to a bottom side of the panel for receiving the object.

22. The print tray according to claim 18, further including a recess defining an area of reduced thickness extending from each opening of the at least one opening to a top side of the panel for reducing print ink deflection at each respective opening.

23. A method for printing an image on an exposed portion of an object, comprising:
(a) providing a tray having an opening on an upper panel for receiving an object thereunder onto which printing is to be applied;
(b) providing a printer having a print head positioned in spaced-apart ink-applying relation to the tray;
(c) placing the object in the tray with a portion exposed in the opening; and
(d) applying the image to the exposed portion of the object as the print head and the tray are moved relative to one another.

24. A method according to claim 23, and including the step of storing the image to be printed on the image surface of the object in an electronic data store and the printer receiving electronic data representing the image to be printed.
